(19) United States
(12) Patent Application Publication
(10) Pub. No.: US 2023/0158361 A1
(43) Pub. Date: May 25, 2023

(54) LEG TRAINING DEVICE

(71) Applicant: Dobrochna Fryc, Wroclaw (PL)

(72) Inventor: Dobrochna Fryc, Wroclaw (PL)

(21) Appl. No.: 18/100,655

(22) Filed: Jan. 24, 2023

Related U.S. Application Data
(63) Continuation of application No. PCT/IB2021/059170, filed on Oct. 6, 2021.

(30) Foreign Application Priority Data
Oct. 7, 2020 (PL) P.435615

(51) Int. Cl. A63B 21/00; A63B 21/06; A63B 21/04; A63B 21/005; A63B 22/00

(52) U.S. Cl. CPC A63B 21/4034; A63B 21/4015; A63B 21/0615; A63B 21/00192; A63B 21/0421; A63B 21/0058; A63B 22/0056

(57) ABSTRACT

Exemplary arrangements provide leg training devices suitable for high intensity training of hip flexors while simultaneously training the extensors of hip and knee joints. The exemplary leg training devices include foot fixings which are permanent vertically movable components of the device, each of which are configured to releasably engage a foot of a user in operative engagement therewith while limiting the movement of the foot relative to the foot fixings. Each of the foot fixings is operatively connected to a suitable mechanism that provides a resistance force to vertical movement of the foot fixing by the user's leg. In exemplary arrangements the resistance force may be selectively variable with regard to the magnitude and/or point of application so as to provide the desired training regimen.

### TECHNICAL FIELD

Exemplary arrangements relate to a leg training device. The exemplary arrangements relate to a training device that is usable for high intensity training of hip flexors while simultaneously training the extensors of hip and knee joints.

### BACKGROUND

There is often a need for leg training and rehabilitation of the legs and hips of individuals. Various devices have been developed for such purposes. However, such devices may benefit from improvements.

### SUMMARY

Exemplary arrangements provide a leg training device for leg strength training and rehabilitation that provides convenient and stable application of a resistance force to the movement of the legs and feet of a device user. The exemplary arrangements include foot fixings that are operative to releasably hold a respective foot of a user and serve to connect the user's foot and leg to the device. Exemplary foot fixings provide precise application of the resistance force so that it is directed axially with respect to the tibia of the user's leg as the foot fixing is moved vertically against the resistance force. Exemplary device arrangements provide a selectively variable resistance force that is suited to the particular leg training or rehabilitation required by the user.

Exemplary arrangements are usable to provide muscle balance in the lower limbs and pelvic girdle. The exemplary balance achieved corresponds to stabilization of posture (including elements relating to the control of pelvic tilt and pelvic portion, as well as to the depth of spine curvatures) and related motor abilities such as balance. Exemplary devices are usable to provide activity in which the muscle group of hip flexors (mainly the muscles iliopsoas, tensor fasciae latae, gluteus minimus and gluteus medius) are subject to a high intensity strength training with simultaneous training of muscles of the hip and the extensors (mainly the muscles gluteus maximus, piriformis, gemelli, internal obturator, quadrates femoris and vastus) and stabilizing muscles. Exemplary arrangements provide for proper positioning of the body and forward support during use of the device, as well as for providing a complex movement pattern that is useful for reducing more morphofunctional disproportions within the muscle groups that are crucial for stabilization.

Exemplary device arrangements provide for the quick and safe mounting of the user's feet to the foot fixings as well as comfortable use of the device. Exemplary arrangements further provide secure engagement of the user's feet to the foot fixings to avoid unwanted movement of the foot relative to the structures which comprise the foot fixings.

Exemplary arrangements provide a leg training device that comprises a support frame with a mechanism operative to provide resistance to foot and leg movement. Connectors in operative connection with the mechanism provides the resistance to movement connected by fasteners to the foot fixings.

In some exemplary arrangements the support frame is connected to the foot fixings using connectors such as a pair of horizontally disposed elongated bars. Each exemplary bar includes a first end and a second end. The first end is in operative connection with a respective pivot while the second end is in operatively attached connection with a respective foot fixing. In exemplary arrangements the pivots are coaxial and the bars are configured such that each user foot in engagement with a respective foot fixing is enabled to move vertically as the bar rotates about a pivot. As used herein reference to vertical movement of the foot and foot fixing refers to substantially vertically which is vertically ±30°.

In some exemplary arrangements the elongated bars of the support frame have gradually bent profiles such that the second ends are disposed further away from one another than the first ends. In some exemplary arrangements at least one weight is in operative connection with the bars such that vertical movement of the foot fixings by a user foot in operative engagement therewith is carried out against a resistance force provided by the at least one weight. In some exemplary arrangements the at least one weight is in operative connection with the spindle. The exemplary spindle is rotatable about a spindle pivot that extends coaxially with the elongated bar pivots. In such exemplary arrangements vertical movement of a foot fixing by a user foot is operative to rotate the respective bar, which bar movement is carried out against the resistance force provided the at least one weight associated with the spindle which is operative to rotate about the spindle pivot responsive to movement of the user foot.

In other exemplary arrangements the exemplary device includes elongated bars that are rotatable about respective pivots at respective first ends and which are engaged to respective foot fixings at the respective second ends. The respective elongated bars are in operative connection with a rotatable wheel. Movement of the elongated bars responsive to vertical movement of the foot fixings by the user's legs is operative to rotate the wheel. In some exemplary arrangements rotation of the wheel responsive to movement of the elongated bars is carried out through a respective ratchet in operative connection with the respective elongated bars. The respective ratchet is operative to impart motion to the wheel to cause wheel rotation in a first rotational direction by resisting movement of a roller or other member which is operatively engaged with the respective bar and wheel, in a first roller rotational direction, while enabling relatively free rotation in a second roller rotational direction as the wheel rotates in the first rotational direction.

In some exemplary arrangements the wheel is in operative connection with a brake. In some exemplary arrangements the brake may be operative to provide a selectively variable brake force which resists wheel rotation in a first rotational direction. In some exemplary arrangements the brake force may include a magnetic system that is operative to position a magnet assembly at a selectively variable distance from the wheel. Such distance may be set in some exemplary arrangements using an adjustable pulley system and a tie rod system suspended in a support frame of the device. In some exemplary arrangements a resistance mechanism may be supported by a magnetic module embedded in a shaft and placed in a support frame of the exemplary leg training device.

In some exemplary arrangements the resistance mechanism provided by the brake includes an electromagnetic system with an electronic module that fixes an electromagnetic assembly. In such exemplary arrangements the force of the electromagnetic field is regulated through the use of electromagnets which are in operatively supported connection with the support frame of the device.

In other exemplary arrangements the device includes a support frame that includes a base and a column. The exemplary base includes side beams, a front beam, a middle beam and a landing mounted on the base. The exemplary support frame further includes a profile arrangement with crossbars and guide rollers with a pulley block system. In an exemplary arrangement a flexible tie rod is guided on the pulley block system. The exemplary tie rod includes first and second ends each of which respective end is in fixed operative connection with the respective foot fixing.

In exemplary arrangements the tie rod is coupled with at least one weight which is movably positioned in the column. The exemplary tie rod is guided by the pulley block system and passes through the weights of a ballasting system. Exemplary arrangements provide for the foot fixings to be in operative connection through the tie rod with the weights such that vertical movement of the foot fixings by a user's foot in engagement therewith is operative to raise at least one weight. Raising of the at least one weight requires overcoming the resistance force provided by gravity acting against the at least one weight.

In exemplary arrangements a regulating system is provided. The exemplary regulating system may include a lever or other suitable mechanism that is operative to change at least one of a point of application of the resistance force during vertical movement of the foot fixing and the resistance force that must be overcome to vertically move the foot fixing to a given vertical level. Further in exemplary arrangements the continuous tie rod is operative to so that as one foot fixing is moved vertically upward from a base against the resistance force produced by the at least one weight, the other foot fixing is biased downward toward the base. Of course these approaches are exemplary.

In other exemplary arrangements the leg training device includes one or more springs which are operative to provide a resistance force against the vertical movement of the foot fixings. In some exemplary arrangements the springs may comprise air springs or similar springs that include pistons in operative connection with piston rods. In exemplary arrangements tie rods, bars or other similar structures are operative to connect the foot fixings and the springs such that vertical movement of the foot fixings is resisted by the springs. In some exemplary arrangements elongated bars that are rotatable about respective pivots at a first bar end, and in operatively fastened connection with a respective foot fixing at a second bar end, may have respective piston rods in hinged connection therewith. Movement of the respective bars responsive to movement of the foot fixings is resisted by the fluid force which opposes movement of the pistons within the air springs. Of course other arrangements utilizing air springs or other types of springs may be utilized.

Other exemplary arrangements include a device having a frame which includes a housing. The housing includes a lid and has an interior area with perforated metal sheets and fixing structures. In this exemplary arrangement a mechanism that is operative to provide resistance to movement of foot fixings includes springs in the form of spiral springs which may be alternatively referred to herein as torsion springs. The exemplary springs are coaxially embedded together with drums. Connectors in the form of tie rod portions are affixed to the drums and free ends of the tie rod portions are in fixed connection with the respective foot fixings through at least one fastener.

In exemplary arrangements the torsion springs which provide the resistance force are in operative connection with a resistance control mechanism that is usable to selectively vary the resistance force. In exemplary arrangements the resistance control mechanism includes a motor that is in operative connection with an input device that receives manual inputs. Manual inputs to the input device are operative to cause the motor operation that selectively varies the resistance force.

The exemplary mechanism includes dividers between respective springs. The springs are located coaxially with drive sprockets, with adjusting sprockets, with sprockets, with adjusting springs and with cogged guides. These elements cooperate in the exemplary arrangement with drive shaft sprockets which are driven by the motor to provide a selectively variable resistance provided by the torsion springs. Of course it should be understood that these arrangements and configurations are exemplary.

Further details of exemplary arrangements are provided in the following Detailed Description.

### BRIEF DESCRIPTION OF DRAWINGS

FIG. 1 is a front perspective exploded view of a first exemplary leg training device including a first resistance arrangement.

FIG. 1A is a rear perspective view of the leg training device shown in FIG. 1.

FIG. 2 is a rear perspective exploded view of an alternative leg training device including a resistance arrangement including a rotating wheel.

FIG. 2A is a left rear perspective view of the training device shown in FIG. 2.

FIG. 3 is a right front perspective exploded view of a further alternative leg training device including a resistance arrangement that includes a plurality of weights arranged in a vertical column.

FIG. 3A is a left front perspective view of the leg training device shown in FIG. 3 with a manually adjustable ballasting system set in a first condition.

FIG. 3B is a left front perspective view of the leg training device shown in FIG. 3 with the manually adjustable ballasting system set in a second condition.

FIG. 4 is a left front perspective partially exploded view of a further alternative training device including a resistance arrangement including springs which comprise air springs including pistons and piston rods.

FIG. 4A is a left front perspective view of the alternative training device shown in FIG. 4.

FIG. 5 is a back top left perspective exploded view of the further alternative training device including a selectively variable resistance force arrangement.

FIG. 5A is a front top right perspective view of the exemplary training device shown in FIG. 5.

FIG. 6 is a top front right exploded perspective view of an exemplary foot fixing of an exemplary leg training device.

### DETAILED DESCRIPTION

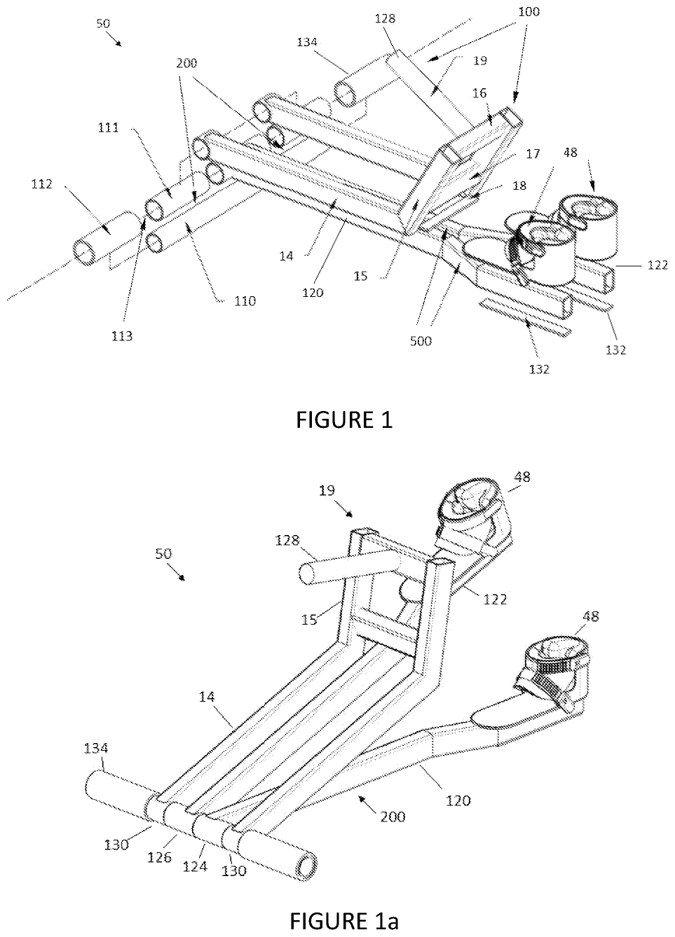

Referring now to the drawings and particularly to FIG. 1 there is shown therein an exemplary leg training device generally indicated 50.

The exemplary device 50 includes a pair of foot fixings 48. Each foot fixing is configured to releasably engage and hold a respective foot of the user in engagement with the device during use. The exemplary device provides a resistance mechanism that is operative to resist the vertical movement of the foot fixings by the user. In this exemplary arrangement the device is operative to apply a resistance to vertical movement of each foot fixing 48 in a vertically upward direction. However in other arrangements the device may provide resistance to vertical movement of the foot fixings both in an upward and in a downward direction.

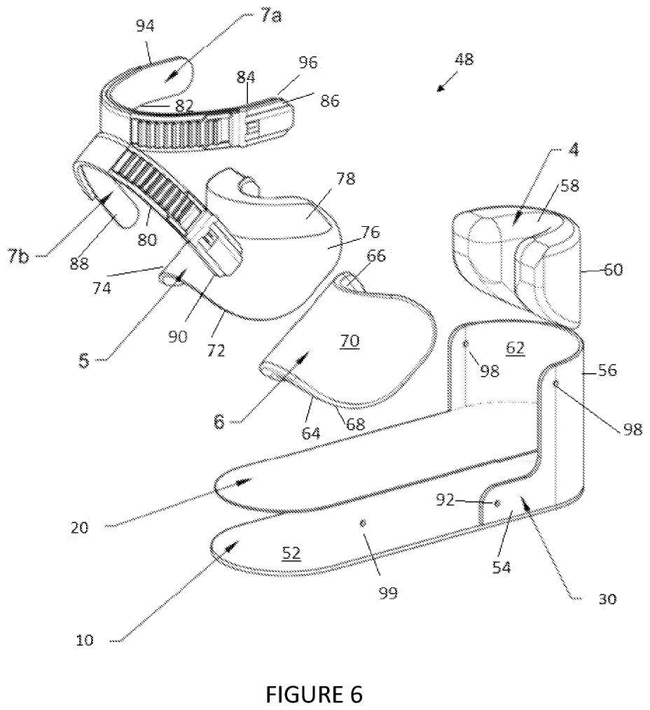

The exemplary foot fixing that is common to all of the leg training device arrangements described herein is shown in greater detail in FIG. 6. As each of the foot fixings in the exemplary arrangement is the same, only one of the foot fixings will be described. The exemplary foot fixing includes a generally flat foot engaging platform 10. As used herein generally flat means that a majority of an upper surface 52 of the platform extends in a common plane. In the exemplary arrangement the platform 10 has an elongated generally rectangular configuration with rounded ends and is comprised of a rigid material such as metal or a rigid plastic. The foot engaging platform is configured to engage the bottom of a foot of the user and is of sufficient length to underlie the toes, sole, arch and heel of the user's foot. Of course it should be understood that this configuration for the platform is exemplary and in other arrangements different configurations may be used.

The exemplary foot fixing 48 further includes a rear wall 30. In the exemplary arrangement the rear wall comprises a curved rear wall that has a U-shape in a transverse horizontal cross section. The exemplary rear wall extends upward from the upper surface 52 of the foot engaging platform. The exemplary rear wall includes a pair of transversely spaced forward portions 54. The forward portions extend on opposed transverse sides of the upper surface 52 of the platform. The exemplary rear wall further includes a back portion 56. In the exemplary arrangement the forward portions 54 are lower in vertical height than the back portion 56.

The exemplary foot fixing further includes a resilient deformable rear cushion 4. In the exemplary arrangement the rear cushion 4 is positioned vertically above the platform and is in fixed operative connection with the platform by being in engagement with the back portion 56 of the rear wall 30. The exemplary rear cushion includes a curved leg engagement surface 58. The leg engagement surface extends perpendicular to the upper surface 52 of the platform in the undeformed condition. The exemplary curved leg engagement surface is configured to engage the back side of a user's leg above the heel when a user's foot and leg is in operative connection with the foot fixing. The exemplary rear cushion 4 further includes an outer U-shape surface 60. The exemplary outer U-shape surface generally corresponds to the inner surface 62 of the back portion 56 of the curved rear wall 30. In the exemplary arrangement the rear cushion 4 is held in fixed engagement with the inner surface 62 by an adhesive or other fastener. However it should be understood that in other exemplary arrangements the rear cushion 4 may be made releasably connectable with the rear wall to facilitate replacement thereof, selective vertical positioning and/or the use of a rear cushion that is customized for use by the particular user. Of course it should be understood that these approaches are exemplary and in other arrangements other approaches may be used.

The exemplary foot fixing further includes a resilient deformable front cushion generally indicated 6. The exemplary front cushion includes an inwardly curved instep engagement surface 64. The exemplary instep engagement surface bounds an inner surface of the front cushion and includes a front portion 66 that is configured to engage and extend over the top of a user's instep, and a pair of side portions 68 that extend downward on each opposed side of the front portion. In the exemplary arrangement the instep engagement surface 64 provides a generally continuous deformable surface that may firmly engage the user's foot across the instep. The exemplary front cushion further includes an outer surface 70. In an undeformed condition the outer surface 70 generally corresponds to the inner instep engagement surface. Of course it should be understood that the configuration of the outer cushion 6 is exemplary and in other arrangements other configurations may be used.

The exemplary foot fixing further includes a profile spacer 5 which may alternatively be referred to herein as a profile washer. The exemplary profile spacer is comprised of a more rigid material then the front cushion 6. In some exemplary arrangements the profile spacer may be comprised of a generally rigid plastic material. The exemplary profile spacer includes a curved profile spacer surface 72. The curved profile spacer surface 72 is in facing relation with the outer surface 70 of the front cushion 6. In exemplary arrangements the curved profile spacer has a configuration that is designed to engage the front cushion in a manner that holds the user's foot through engagement with the instep in generally fixed operative connection with the foot fixing. In some exemplary arrangements the configuration of the curved profile spacer surface may be configured to deform and hold the front spacer in the desired location in underlying relation of the profile spacer during use of the device. In some exemplary arrangements different structures such as projections or fasteners may be provided for purposes of assuring that the curved profile spacer surface and the front cushion maintain their desired positions during use.

The exemplary profile spacer 5 further includes an outer surface 74. The outer surface includes guides 76, 78. In the exemplary arrangement the guides are configured to engage and hold in position the releasable bindings 7a and 7b which are later discussed. In the exemplary arrangement the guide 76 includes a curved outer surface that is configured for engagement with an overlying inner face 80 of releasable binding 7b. The exemplary guide 78 includes a curved forward facing surface that is configured for engagement with an inner face 82 of releasable binding 7a. Of course it should be understood that these guides are exemplary and in other exemplary arrangements guides may have different structures to accommodate holding in position other types of releasable bindings. Such guides in alternative arrangements may include projections, recesses, apertures, hooks or other suitable structures that are operative to hold releasable bindings in the appropriate position during use.

The exemplary foot fixing includes the pair of releasable bindings 7a and 7b. Each releasable binding includes an adjustable fastener 84. The adjustable fasteners of the exemplary arrangement comprise adjustable straps that enable the longitudinal length of the respective releasable binding to be varied. This may be done through a suitable ratchet, ridge, aperature, slotted, buckle or loop arrangement or other type of adjustable fastener that enables the length of the adjustable strap to be changed to a length that is suited for holding the foot of the user in operative engagement with the foot fixing. The exemplary releasable binding further includes a release 86. In exemplary arrangements the release 86 may comprise a suitable buckle or tab. Actuation of the exemplary release 86 is operative to change the releasable binding between an engaged condition and a disengaged condition.

In the exemplary arrangement the releasable binding 7b includes opposed ends 88 and 90. The opposed ends 88 and 90 of the releasable binding 7b are in operative engagement with the transversely disposed forward portions 54 of the back wall 30. The ends 88 and 90 may be engaged to the forward portions through suitable fasteners schematically represented 92. In exemplary arrangements the fasteners may extend through openings in the forward portions that enable the releasable binding 7b to be somewhat rotatably movable relative to the upper surface 52 of the platform 10. Of course this approach is exemplary and in other arrangements other types of fasteners may be used.

Releasable binding 7b includes opposed ends 94, 96. In the exemplary arrangement the opposed ends are attached to the opposed sides of the U-shaped back portion 56. Opposed ends 94, 96 are attached to the back portion 56 through fasteners schematically indicated 98. Fasteners 98 in the exemplary arrangement may also be fasteners of the type that provide rotational movement of the releasable binding 7a relative to the platform. As can be appreciated, in the exemplary arrangement in the engaged condition of the releasable binding 7a, the releasable binding extends in engagement with the rear portion on both of the opposed sides of the rear cushion. This helps to hold the leg of the user in engagement with the foot fixing 48 with only a suitable limited degree of relative movement of the foot and leg to the foot fixing.

The exemplary foot fixing further includes a resilient anti-slip overlay generally indicated 20. In the exemplary arrangement the anti-slip overlay comprises a resilient layer or pad of deformable material that overlies the upper surface 52 of the foot engaging platform and extends in underlying relation of the bottom of the user's foot. In the exemplary arrangement the anti-slip overlay comprises a generally flat planar pad that conforms to the configuration of the upper surface 52. However it should be understood that in other arrangements the anti-slip overlay may have a configuration designed to conform to the shape of the bottom of the user's foot. This may include for example the overlay including raised areas or areas providing greater cushioning that conform to the contour the arch of the foot, the area of the toes, or the heel. Further in some exemplary arrangements the anti-slip overlay may be customized to the foot of the user. Of course these approaches are exemplary and in other arrangements other approaches and structures may be utilized.

In the exemplary arrangement the platform 10 of each of the foot fixings is engaged with at least one fastener which is schematically indicated 99. The exemplary at least one fastener 99 which is alternatively referred to herein as a connector, is operative to connect the foot fixing in a manner that causes the resistance force that is applied by the leg training device, to resist vertical movement of the foot fixing and the leg and user foot of the user during use of the device. In exemplary arrangements the at least one fastener 99 and the foot fixing are configured so that when the foot of the user is in operatively engaged relation with the foot fixing, the resistance force is applied to the foot fixing in a manner that is directed coaxial with the tibia of the leg of the user that is in operative engagement with the respective foot fixing. In this exemplary arrangement the foot fixing operates to direct the resistance force in a manner that assures that the user receives the maximum benefit from the use of the device in strengthening the desired musculature structures and also minimizes the risk of injury to other body structures that could result from the resistance force being improperly directed.

In the exemplary arrangement the pair of releasable bindings are operative to releasably hold a user's foot and leg in operative engagement with the foot fixing. In the exemplary arrangement in the engaged condition of the binding, the releasable bindings extend in outwardly overlying relation of the outer surface 74 of the profile spacer 5 and in outwardly overlying relation of the front cushion 6. In the engaged condition of the releasable bindings the foot of the user is held in operatively engaged relation with the foot fixing 48 in a manner that assures that the resistance force is applied coaxially with the tibia of the user's leg in engagement with the foot fixing. In the exemplary arrangement each of the releasable bindings are changed from the engaged position to the disengaged position through actuation of the release 86 of the respective releasable binding. In the disengaged condition the foot of the user is enabled to disengage from the foot fixing. Exemplary arrangements are configured to readily enable the user to place the releasable bindings in the disengaged conditions and position their feet in the respective foot fixings 48 of the leg training device. Once the user's feet are positioned in the respective foot fixings 48, the exemplary bindings may be adjusted and placed in the engaged condition so as to hold the feet of the user in operative engagement with the foot fixings such that the vertical movement of the user's legs and feet are operative to move the respective foot fixings against the resistance force as applied by the device in the manner later discussed.

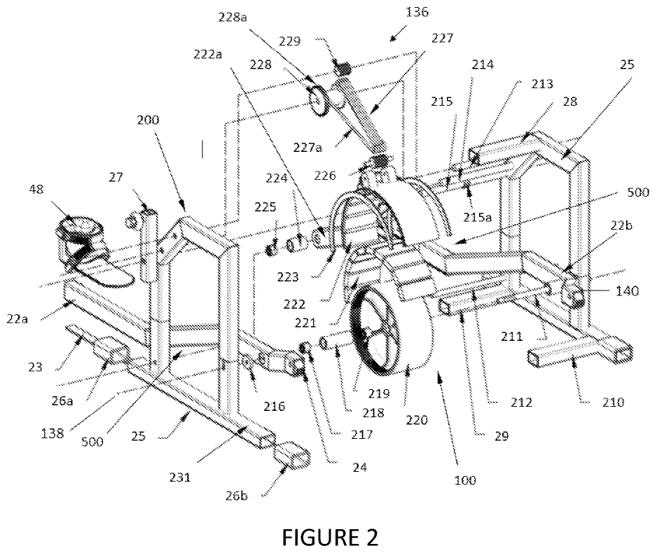

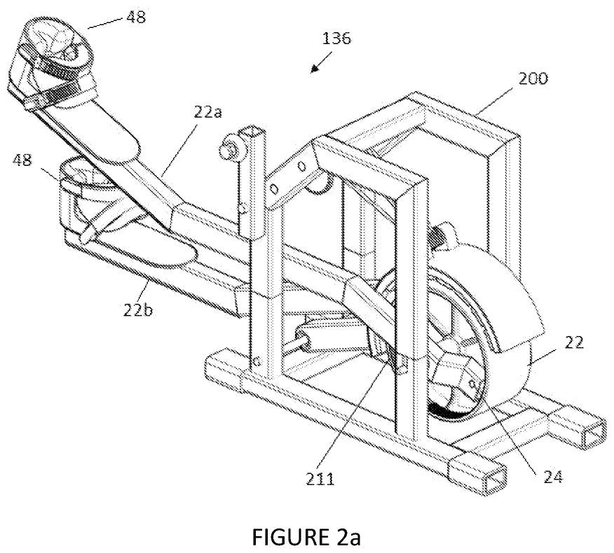

Returning to the discussion of the exemplary leg training device 50 shown in FIGS. 1 and 2, the exemplary device includes a resistance mechanism generally referred to as 100 which in the exemplary arrangement operates to provide the resistance force that opposes the vertical movement of the foot fixings 48. In this exemplary arrangement the foot fixings are attached by the respective at least one fasteners 99 to respective horizontally transversely disposed elongated bars and 120, 122. The elongated bars are alternatively referred to herein as connecting members 500. The exemplary device includes a support frame generally indicated 200. Bushings 110, 111 and 112 are operative to provide movable pivots for the elongated bar members. A first end of bar 120 is in operative connection with and rotatable about a pivot 124 while the second opposed end of the bar 120 is in attached connection with the respective foot fixing 48. A first end of elongated bar 122 is in operative connection with a pivot 126. The pivots extend along a common axis 113. The second opposed end of elongated bar 122 is in fixed operative connection with a foot fixing 48. In the exemplary arrangement the elongated bars 120, 122 have a shaped profile such that they are horizontally closer together at the first ends than at the second ends to which the foot fixings are attached. The foot fixings are disposed horizontally apart at a distance that is suited to the spacing of the feet of the user.

In the exemplary arrangement a spindle 19 comprises an attached weight 128. The spindle 19 includes a pair of support profile bar members 14, 15 which are in attached connection and disposed in angular relation. A first end of each support bar profile member 14 is in operative connection with a respective spindle pivot 130. Each spindle pivot is rotatable about the axis 113. The profile bar members 15 of the spindle 19 are connected by a transversely extending upper beam 16 and a transversely extending lower beam 17. In the exemplary arrangement the lower beam 17 is generally at about the vertical height of the top surface of each of the elongated bars 120, 122. In the exemplary arrangement a cushioning rubber cover 18 is provided on the lower surface of the lower beam 70. In the exemplary arrangement the weight 128 is in fixed attached connection with the upper beam 16.

In the exemplary arrangement the undersides of the second ends of the elongated bars 120, 122 each have attached thereto resilient pad members 132. The exemplary resilient members serve to absorb impact forces and prevent scraping or other damage to an underlying floor surface by the bottoms of the second ends of the bars during operation. In the exemplary arrangement the outer surfaces of the bushings 112 also include resilient annular covers 134. The resilient covers serve to also prevent damage to the underlying floor as well as to prevent unwanted movement of the training device during operation.

In the exemplary arrangement the spindle 19 with the weight 128 attached thereto is operative to apply a downward gravitational force which acts against each of the elongated bars 120, 122. As the user operates the device to vertically lift a respective foot fixing 48 with their foot the spindle along with the weight thereof applies a resistance force which opposes the upward movement of the elongated bar and the respective foot fixing. As the user moves one of the foot fixings upward, the elongated bar in operative engagement with the lower beam 17 of the spindle 19 causes the spindle to rotate about the spindle pivot 130. As the user lifts their foot the spindle pivot rotates in a common rotational direction with the pivot at the first end of the elongated bar which is being raised by the user's foot. After the user has raised the foot a sufficient distance, the user may move their foot downward, moving with the force applied by the spindle. The spindle and the elongated bar rotate in a common rotational direction opposed to the direction in which they rotate while the foot is being lifted, until the pad on the bottom of the elongated bar is again in engagement with the floor or other supporting surface. The user may then carry out a similar activity, raising their other foot. The raising of the other foot will be similarly resisted by the resistance force produced by the weight 128 and the spindle 19.

It should be understood that while in the exemplary arrangement the weight is attached in operative connection in centered relation with the upper beam 16, in alternative arrangements other configurations may be used. For example in some arrangements a transverse beam associated with a spindle may be set to extend vertically upwards. Alternatively in other arrangements the weight may have different configurations or extend at different angles or in different locations. Further in other exemplary arrangements the transverse member of the spindle may be in the form of a platform that includes weights of different configurations thereon. Such a platform may include a platform of a horizontally elongated configuration. Further in some exemplary arrangements the spindle may be configured with a support to which a plurality of weights may be added or removed. This may include for example one or more rods which may engage openings in weights to hold them in aligned arrangement. Weights may be added or removed in exemplary arrangements to achieve a variable resistance force that opposes movement of the foot fixings in the vertical direction. Of course it should be understood that these configurations are exemplary and in other arrangements other approaches may be used.

FIGS. 2 and 2a show a further alternative arrangement of a leg training device generally indicated 136. In this exemplary arrangement a magnetic system is operative to provide a resistance force to the vertical movement of the foot fixings 48. This exemplary system includes connectors generally referred to 500 which comprise elongated bar members 22a and 22b with bent profiles. Similar to the previously discussed arrangement respective foot fixings 48 are in attached connection with the respective second ends of the elongated bars. The exemplary device 136 includes a support frame 200. The frame includes a rectangular horizontally disposed side frames 25 with a truncated top corner and a series of crossbars such as an upper beam 28 a front beam 29 and a rear beam 210. The lower profile members 231 of the side frames 25 provide a supporting function and are provided with rubber covers 26a and 26b which provide cushioning, provide a stabilizing function and prevent movement and damage to the underlying floor structure.

In this exemplary arrangement a resistance mechanism again generally referred to as 100 includes a rotatable wheel 220. In the exemplary arrangement the rotatable wheel is a wide wheel which is rotatable about a shaft 211 which extends along an axis 138. A fixed magnet assembly 221 is secured upon the support frame 200 using a magnetic module frame 222. In the exemplary arrangement the distance of the magnet assembly relative to the wheel is adjustable through a tie rod system 227. In the exemplary arrangement the wheel comprises a steel alloy to interact with the magnet assembly 221 so as to achieve providing a selectively variable resistance force. It should be understood that in some arrangements the wheel 220 may be comprised entirely of a steel alloy material while in other arrangements only an outer ring or other components may be comprised of steel material.

In the exemplary arrangement the elongated bar profile bar members 22a and 22b are each movably mounted in operative connection with the frame through a respective pivot that is rotatable about the axis 138. Each of the profile bar members 22a and 22b has forward extensions 140 that extend beyond the respective pivot in a direction opposed of the direction toward the foot fixings. Each of the extensions have at a distal end thereof away from the pivot, a respective ratchet 24. In the exemplary arrangement the respective ratchet 24 is in operative connection with a roller, gear or similar member that extends outward from the extensions 140 and is configured to engage the wheel 220. For purposes of this description all such members engaged with the ratchet shall be referred to as a roller. In exemplary arrangements the roller is configured to engage an inner circumferential surface of the rotatable wheel 200. In exemplary arrangements the ratchet is configured so that the roller in engagement with the wheel is prevented from rotating in one rotational direction so that during movement of the extension in a first direction the roller is prevented from moving so that the movement of the extension urges rotation of the wheel in a first rotational direction. The exemplary ratchet is further configured such that movement of the extension in an opposed direction enables the roller to rotate relatively freely such that the extension and the elongated member may move in the opposed direction without applying a counterforce that impedes the rotation of the wheel in the first direction. Of course it should be understood that this approach is exemplary and in other arrangements other approaches may be used.

The exemplary structure includes a shaft 211 that extends along the axis 138. The shaft 211 connects the rear vertical profiles of the support frame 200. The shaft 211 is operative to provide the support for the rotatable wheel 220 and the elongated profile members 22a and 22b and supported in engagement there with. Each of the elongated bar members is operatively connected with the shaft 211 through a bearing 217 that is recessed into a bushing 218 at an end thereof connected next to the wheel 220. At the underside second ends of the elongated profile members 22a, 22b and underline relation of the foot fixings are cushioning rubber covers 23. The shaft 211 further extends through spacing dividers 216. The spacing dividers operate to separate the outboard side of each elongated profile member 22a, 22b from the adjacent upright frame to facilitate the movement of the elongated profile member.

The exemplary wheel 220 is in supported movable relation on the shaft 211 using a bearing 219. The exemplary arrangement of the wheel 220 with the magnetic module frame 222 which fixes the magnet assembly 221 a variable distance from the wheel, is controlled by a pulley lock system 226, 228 and 229 and a tie rod system 227 that is suspended in the support frame 200. The exemplary magnetic system that provides resistance to wheel and foot fixing movement is supported on the bottom side by a magnetic module frame 222 that has an arm 222a with an opening embedded on a shaft 212 located in the support frame 200 between the side frames. Of course it should be understood that this configuration is exemplary.

The rotatable wheel 220 is wider in the peripheral portion than in a central area. On the inside of the wheel a circumferential outward extension of the wheel 220 may be serrated in a way that corresponds to the roller or other rotatable member that is in operative connection with the ratchet 24 on the extensions 140 of the elongated profile bars 22a, 22b. In this exemplary arrangement the ratchet is configured so that resistance is only generated against movement of the user lifting their leg that is positioned in a foot fixings 48 that is coupled to an elongated profile bar member. The resistance to movement of the foot fixings is provided by a magnetic module frame 222 having a shape similar to that of the wheel 220. The magnetic module frame is provided with an arm 222a and a pulley block fixings system of the tie rod system 227. The exemplary tie rod system 227 includes a lower pulley lock system 226, a wire rope 227a, a pulley block 228 of the tie rod system 227, and the upper pulley block system 229. A magnet assembly 221 fixed by the side profiles 223 is provided inside the fixing magnetic module frame 222 that fixes the magnet assembly 221 of the resistance mechanism. The exemplary arm 222a of the magnetic module frame 222 has an end when a bushing 224 and a bearing 225 that allows the magnetic module frame 222 to rotate relative to the axis 138 defined by the shaft 212. The exemplary shaft 212 is embedded on profiles of the support frame 200. In the exemplary arrangement the configuration of the elongated profile bars 22a, 22b have a shape that is configured so that the foot fixings 48 pass above the shaft 212 during operation of the device.

The resistance mechanism is suspended in the support frame 200 from the upper, top side of the magnetic module frame 222 and is suspended using a lower pulley block system 226 of the tie rod system 227 for adjusting the resistance to vertical movement of the foot fixings. In the exemplary arrangement the distance of the magnetic module frame 222 from the wheel 220 varies the resistance force using an upper pulley block system 229 located on the shaft 213 of the tie rod system 227, in which the shaft 213 is located between the diagonal profiles of the side frames 25 of the upper support frame 200, and below the upper beam 28 of the support frame 200. Below the shaft 213, between the oblique beams of the side frames 25, there is a shaft 214 of the pulley block 228 of the tie rod system 227, on which there is a drum 228 provided on one side of a sprocket wheel 228a that corresponds to a smaller sprocket wheel 215a formed on the shaft 215 of an adjusting crank 27. The shaft 215 is located below the shaft 214 of the pulley block 228, and when recessed into the side frame 25, has the adjusting crank 27 at the end of the right side of the side frame 25 as shown. A wire rope 227a which serves as a tie rod in the tie rod system 227, is wound onto the pulley block 228 during adjustment by rotating the adjusting crank 27 and passes through the two pulley block systems 226, 229 several times.

In alternative arrangements an electromagnetic system may be utilized in which the force of the magnetic field is made variable. This may be achieved in such alternative arrangements through the use of circuitry which is operative to adjust the magnetic force produced by electromagnets. In alternative arrangements the distance between the magnet assembly and the rotatable wheel 200 may be made adjustable. This may be accomplished in some arrangements by using a motor driving a tie rod shaft or in alternative arrangements by using a chain so as to provide a selectively variable resistance force. Of course it should be understood that these arrangements are exemplary and in other arrangements other structures for providing a suitable resistance force may be utilized.

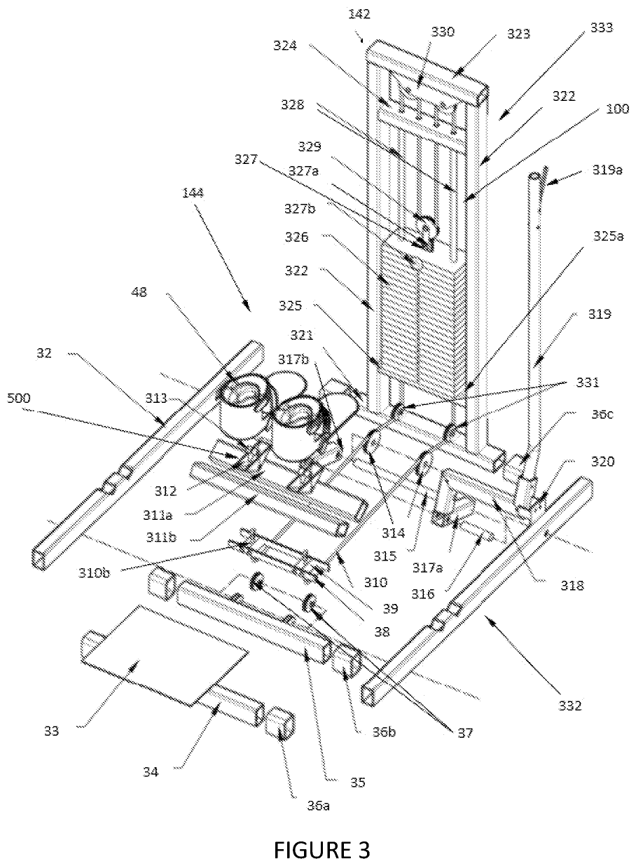

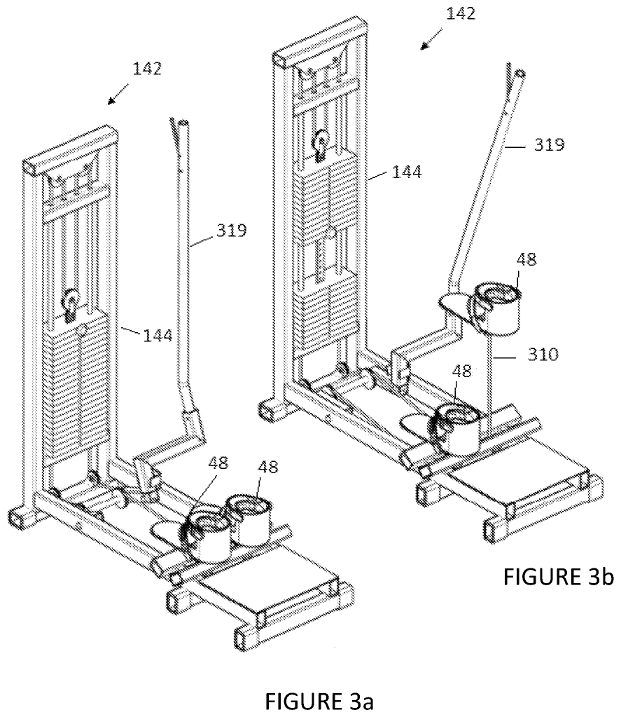

A further alternative exemplary leg training device 142 is shown in FIGS. 3, 3a and 3b. This exemplary arrangement comprises a system that has some similar features to the others previously described and provides a resistance force against the vertical movement of the user's legs and feet that are in operatively engaged relation with foot fixings 48. Also like the other arrangements previously discussed herein, this exemplary arrangement is operative to apply the resistance force which opposes vertical leg movement in axially aligned relation with the tibia of the user's leg.

The exemplary arrangement provides a resistance force based on a stationary weight system which includes a column 333 with a weight stack, and a tie rod system that includes a tie rod 310 and a pulley block system 37, 314 and 331. In the exemplary arrangement the exemplary tie rod 310 which is alternatively referred to herein as a flexible tie bar, is a single continuous flexible member. In the exemplary arrangement a first end of the tie rod is in fixed operative connection with a first one of the foot fixings 48 through operative engagement of the at least one fastener 99 which operatively engages the platform 10 thereof with the flexible tie rod. A second opposed end of the tie rod is in fixed operative connection with the other of the foot fixing 48 through the respective at least one fastener 99 thereof. The exemplary arrangement of the leg training device which provides for the flexible tie rod to be in operative connection with the weight, provides a resistance force against the vertically upward movement of a foot fixing and causes the other foot fixing to be biased downward holding the other foot fixing that is not raised in engaged relation with profile members 312 which provide a lower base upon which the foot fixings are operatively supported in their lowermost positions.

In other exemplary arrangements the exemplary profile members 312 may include spindles with spacers 313. In such exemplary arrangements any slack in the flexible tie rod 310 may be taken up so that it remains in a position that is unchanged. In some exemplary arrangements the flexible tie rod 310 may comprise a wire rope. Further in exemplary arrangements the profiles 312 may be configured in such a way that they correspond to supporting profile bars 311a and 311b which in exemplary arrangements may extend obliquely and serve as cross bars for support of the device frame which is generally indicated 144.

The exemplary support frame 144 comprises a base 332. The base includes side beams 32, a front beam 34, a middle beam 35 and a landing 33 which is mounted on the base. In the exemplary arrangement, front beam 34 and middle beam 35, function as supports and have a suitable rubber cover 36a and 36b. Arranged in front of the support profile bars 311a, 311b, on the side beams 32 of the base 332, there is a landing 33 in the form of a rectangular platform. Below the support profile bars 311a, 311b, there are two ledges forming crossbars 38 upon which pairs of guide rollers 39 are arranged. The guide rollers 39 are operative to hold the position of the tie rod 310 within the limits of lateral reflections below the support profile bars. Extending from the guide rollers 39 the flexible tie rod passes through the pulley blocks 37 that is secured on the middle beam 35. The flexible tie rod then changes direction passing at the top to the pulley blocks 314 of the ballasting system 319 to the column 333 of the resistance mechanism.

In the exemplary arrangement the ballasting system 319 comprises a lever 319a with a limiting module 320. Crossbars 318 are attached to the lower part of the lever 319a in the form of longitudinal L-shaped bar profiles, with a first side profile 317a at its end. Side profile 317a is located at the profile of the side beam 32 of the support frame 144. At the at the second side beam 32 profile, there is a second symmetrical side profile 317b. A system of shafts 315, 316 serve as connectors on which the profiles of the ballasting system 319 rotate relative to the support frame 144. On the main shaft 315 of the ballasting system 319 which is located between the distal ends of the side profiles 317a, 317b of the ballasting system 319, there are pulley blocks 314 on which the tie rod rotates. The other two rollers comprise side shafts 316 which connect the proximal ends of the side profiles 317a, 317b of the ballasting system 319 with side beams 32 of the base 332 of the support frame 144 to form a transverse axis of rotation. The exemplary ballasting system also has a limiting module 320 that operates to limit the movement range of the lever 319a located on the right side beam 32 of the support frame 144. The exemplary C-shaped limiting module 320 provides only two stable positions for the lever 319a. In a distal position of the lever 319a the lever is directed toward the column 333 of the resistance mechanism, thereby causing strain relief of the tie rod 310. In a proximal position of the lever 319a the lever causes the tension in the tie rod 310 and the weighing down of the resistance mechanism. Thus in the exemplary arrangement the ballasting system 319 enables control of at least one of the vertical level of the foot fixing at which the resistance force is encountered and the magnitude of the resistance force for a given level of vertical displacement of the foot fixing. Of course it should be understood that this approach is exemplary and in other arrangements other approaches may be used.

The weight column 333 is connected to the support frame 144 using a transverse lower beam 321 of the column. Due to its supporting nature the lower beam 321 has lateral rubber covers 36c. The frame shaped column 333 also includes two side beams 322 on profile members, an upper beam 323, an upper crossbar 324 and a lower crossbar 325 which includes a cushion 325a for the weight stack 326. The exemplary weight stack 326 of the resistance mechanism is located on the lower crossbar 325. Between the upper crossbar 324 and the lower crossbar 325, there are two guiding profile members 328 which in the exemplary arrangement comprise tubes. However it should be understood that in other exemplary arrangements there may be different cross-sectional shapes for the guiding profile members 328 as well as for the other profile members which serve as guides in the device. The exemplary tie rod 310 runs inside the guiding profile 328. In the weight stack 326 there is provided a perforated ledge 327a and a spindle 327b with a knob. This arrangement comprises a load regulation system 327 of the weight stack 326 which enables selectively varying the resistance force opposing vertical movement of the foot fixings 48.

The exemplary tie rod 310 which is attached at its opposed ends to the foot fixings, passes through the pulley block system 37 and successively through the pulley block system 314 of the ballasting system 319. The tie rod then enters the column 333 through the bottom pulley block system 331, passes vertically through the guiding profile member 328 of the weight stack, passes through the top pulley block system 330 located on the bottom side of the transverse upper beam 323, and returns to the central pulley block 329 which is engaged with the perforated edge 327a that binds the weight stack. The exemplary tie rod 310 then returns sequentially through the top pulley block system 330 to the bottom pulley block system 331, sequentially into the pulley block system 14 of the ballasting system 319, through the pulley block system 37, connecting at its end with the foot fixing 48 through the respective at least one fastener 99 thereof.

In exemplary arrangements the ballasting lever 319a of the ballasting system 319 may be used to reduce the backlash in the initial phase of foot lift movement. The exemplary tie rod 310 is connected at its respective ends to the foot fixings 48 by passing through the spindles placed in the profiles 312 which have a shape corresponding to two inclined profile bars 311a, 311b which in the exemplary arrangement comprise diagonally arranged crossbars placed on the support frame 144 which operatively provide support for the support base for the foot fixings 48. In exemplary arrangements the tie rod is directionally stabilized by the pulley block systems 37, 314, 329, 330 and 331 and at this stage between the support profile bars 311a, 311b as well as at all locations of a directional change. While in other exemplary arrangements other configurations may be utilized for the base profiles 312, it may be useful that the return path of each foot fixing 48 from a vertically elevated position above the base downward, operative engagement with the base is unequivocal to prevent twisting or shifting of the foot fixing 48 relative to the structures that are provided for the receipt thereof by the support profile bars 311a, 311b. Of course it should be understood that these arrangements are exemplary and in other arrangements other approaches may be used.

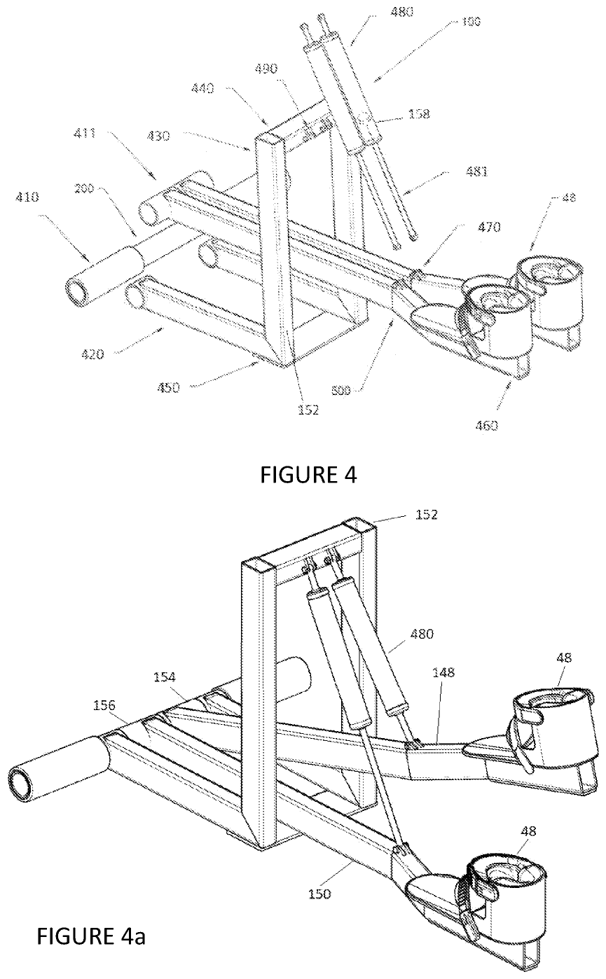

A further alternative arrangement of the leg training device 146 is shown in FIGS. 4 and 4a. This exemplary arrangement includes a pair of foot fixings 48 that are each respectively in attached operative connection with respective elongated profile bars 148, 150 which are generally referred to as connectors 500. The exemplary arrangement includes a support frame 152. The support frame is rotationally connected to the elongated bars 148, 150 through respective pivots 154, 156 using bushings 410. In the exemplary arrangement resistance to vertical movement of the bars and foot fixings is provided by springs 480 which in the exemplary arrangement comprise air springs. The exemplary springs include cylinders 480 in which internal pistons 158 are longitudinally movable in operative connection with piston rods 481. In the exemplary arrangement the movement of the pistons 158 within the cylinders is resisted by fluid pressure on one or both transverse sides of the pistons.

The exemplary support frame 152 includes lower beams 420 and side beams 430 that are connected by a transversely arranged upper crossbar 440 and a lower crossbar 450. The configurations of the lower beams 420 of the support frame 152 and the bars 148, 150 include transverse bushing sleeves 410 at a distal end such that the pivots 154, 156 are constrained to rotate about a common axis. The respective foot fixings 48 are in operatively fixed connection at the ends of the bars 148, 150 an opposed ends from the pivots. The lower ends of the bars 148, 150 are provided with cushioning rubber cover pads 460. In the exemplary arrangement the lower crossbar 450 is attached on the bottom side to the lower beams 420 at a proximal portion thereof where the lower beams 420 connect with the side beams 430. The upper crossbar 440 is located at the top of the side beams 430.

The upper crossbar 440 includes upper hinge fixings 490 which are configured to rotationally engage the upper mounting apertures of the cylinders 480. The piston rods 481 of the cylinders 480 are in rotationally engaged connection at their proximal ends to suitable hinged fixings 470 that are positioned on the respective bars 148, 150. As a result the air springs as provided by the cylinders 480, are configured in some exemplary arrangements to provide resistance force that opposes the upward vertical movement of the foot fixings. Alternatively in other arrangements with different cylinder configurations the movement of the foot fixings both vertically upward and vertically downward may be subject to a resistance force. Various resistance force arrangements may be achieved by controlling the pressure on the transverse sides of the respective pistons 158 within the cylinders 480.

The exemplary device 146 implements a solution in which the resistance from the resistance mechanism generally referred to 100 may be transferred from the cylinders 180 mounted on the support frame 152 through the piston rods 481. In this exemplary arrangement the axis of rotation of the pivots 154, 156 is spaced from the foot fixings 48 and the point of engagement of the cylinders such that the piston rods are connected thereto in a manner that provides the desired level of resistance to vertical movement of the foot fixings. Of course it should be understood that these approaches are exemplary and in other arrangements other approaches may be used.

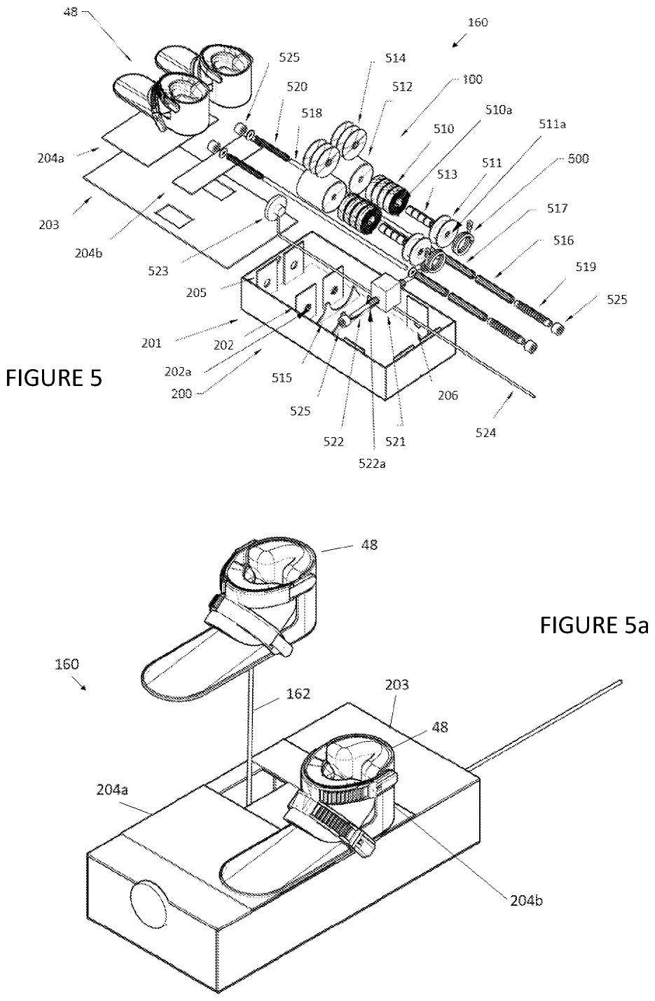

FIGS. 5 and 5a show a further alternative exemplary arrangement of the leg training device generally indicated 160. This exemplary arrangement also comprises a pair of foot fixings 48 for which the vertical movement thereof is resisted by a selectively variable resistance force. Again as with the other exemplary arrangements herein, resistance force is applied through the leg fixings in axially aligned relation with the respective tibias of the legs of the user.

In this exemplary arrangement the resistance force is provided by a spring-loaded mechanism that includes a series of spiral springs 510 which may alternatively be referred to herein as torsion springs. The springs 500 are coaxially arranged with drums 511. In the exemplary arrangement each drum is operatively connected via a flexible tie rod portion 162 to a respective foot fixing 48. In the exemplary arrangement the tie rod portions comprise wire ropes that are wound onto the drums 511. The exemplary arrangement includes a resistance control system. The resistance control system includes a motor 521. The motor is in operative connection with an input device 523, which is operative to receive manual inputs. The exemplary input device 523 may comprise a rotatable dial. The input device 523 is operatively connected to the motor through a suitable electric cable 524.

In the exemplary arrangement the device 160 includes housings 512. The respective springs 510 are attached externally to the housing. The springs are attached internally to sprockets 513 and are separated by spacers 514 that are positioned on rings. The housings 512 of springs 510 are attached via fixing profile members 515 to a housing 201 which serves as a support frame. Perforated metal sheets 202 that are fixed to the housing are also in operatively attached connection with the housings 512. Perforated metal sheets 205 are provided for engagement of the housings at the proximal and distal walls, while perforated metal sheets 206 are provided at the sidewalls.

In the exemplary arrangement the force from the springs 510 is transferred to a respective tie rod portion 162 through a drive sprocket 516 which conforms to a sprocket 511a formed in the drum 511, and the sprockets 513 of the springs 510. The adjusting sprocket 517 conforms with the sprockets 513 of springs 210 and stabilizing sprockets 202a disposed in the perforated metal sheets 202 behind the mechanism including the springs 510. The sprockets are disposed on a common axis 518 with the drive sprocket 516. The position of the drive sprocket 516 and the adjusting sprocket 570 is adjusted by a cogged guide 519 on the proximal side and by the adjusting spring 520 on the distal side. The cogged guide 519 conforms to sprockets 522a that are provided on the driveshaft 522 connected to the motor 521. The cogged guides 519 and the adjusting spring 520 are movably mounted by supporting bearings 525.

Spacers 514 are provided on rings, which rings are an integral part of the spacers 514 and have a diameter that allows them to slide freely over the adjusting sprocket 517 and the drive sprocket 560. The adjusting sprocket 517 and the drive sprocket 516 have a similar cross section and are aligned with sprockets 513 of the springs 510 in such a way that if the drive sprocket 516 is located inside the sprocket 513 of the spring 510, it transfers the torque generated during the deflection of the spring 510 from the rotational movement of the drive sprocket about the axis. If the adjusting sprocket 517 is located in the sprocket 513 of the spring 510, it prevents the spring 510 from unwinding while maintaining its base resistance via the sprocket 202a and the perforated metal sheet 202 located behind the housing 512 of the springs 510. In the exemplary arrangement the rings in spacers 514 allow for given margin of error, a room for maneuver in the adjustment system because they do not have a sprocket like cross section and are a point where the stationary (rotationally relative to the axis, adjusting sprocket 517) and the rotationally movable drive sprocket 516 meet.

The cogged guide 519 is moved along the axis using transverse strips. Therefore the position of the point of contact between the drive sprocket 516 and the adjusting sprocket 517 is varied. This point of contact can have a position between the drum 511 and the first spring 510. The point of contact may alternatively be under the spacer ring between the first and second rings 510. A further alternative position of the point of contact may be under the spacer ring 514 between the second and third springs 510. The point of contact may also be under the spacer ring 514 between the third and fourth spring 510. The point of contact may also be between the port spring 510 and the sprocket 202a located in the perforated metal sheet 202 behind the spring housing 512 of the springs 510.

The cogged guide 519 which controls the point of contact between the drive sprocket and the adjusting sprocket is selectively moved by the driveshaft 522 which is driven by the motor 521. The rotation of the driveshaft is controlled responsive to manual inputs to the input device 523. As a result the resistance force which resists the vertical movement of each of the foot fixings may be selectively variable.

The exemplary sheet metal housing 201 which serves as a support frame in this exemplary device arrangement, includes a lid 203. The lid is perforated so as to have openings where the tie rod portions 162 pass therethrough. The exemplary lid includes a respective top rubber cover 204a, 204b located in the area where the points of contact occur with the under sides of the platforms 10 of the foot fixings 48. In the exemplary arrangement the user is enabled to selectively vary the resistance force to the vertical movement of each of the foot fixings 48 by providing the inputs to the input device 523 during use of the device 160. Of course these approaches are exemplary and in other arrangements other approaches and configurations may be used.

Thus the exemplary arrangements of the leg training devices described herein achieve improved operation, eliminate difficulties encountered in the use of prior devices and systems, and attain the useful results that are described herein.

In the foregoing description certain terms have been used for brevity, clarity and understanding. However no unnecessary limitations are to be implied therefrom because such terms are used for descriptive purposes and are intended to be broadly construed. Moreover the descriptions and illustrations herein are by way of examples and the new and useful features of the exemplary arrangements are not limited only to the features and relationships that have been shown and described.

Further it should be understood that the features and/or relationships associated with one exemplary arrangement can be combined with features and/or relationships from another arrangement. That is, various features and/or relationships from the various arrangements can be combined in further arrangements. The new and useful scope of the disclosure is not limited only to the arrangements that have been shown and described herein.

Having described the features, discoveries and principles of the exemplary arrangements, the manner in which they are constructed and operated, and the advantages and useful results attained, the new and useful features, devices, elements, configurations, parts, combinations, systems, equipment, operations, methods, processes and relationships are set forth in the appended claims.

I claim:

1. Apparatus comprising:
a leg training device configured to provide resistance to vertical movement of each foot of a user of the device,
wherein the device includes a pair of foot fixings,
wherein each foot fixing is configured to hold a respective user foot in operative engagement therewith during device operation,
wherein each foot fixing includes
a generally flat foot supporting platform, wherein the platform is configured to operatively engage a bottom of one respective user foot and underlie the toes, sole, arch and heel of the respective foot,
a resilient rear cushion, wherein the rear cushion
extends above and is in fixed operative connection with the platform,
includes a curved leg engagement surface,
wherein the curved leg engagement surface
extends perpendicular to the platform,
is configured to engage a back side of a user leg above the heel when the foot is in operative engagement with the foot fixing,
a resilient front cushion, wherein the front cushion
includes a curved instep engagement surface, wherein the instep engagement surface is configured to engage an instep of the foot,
at least one releasable binding, wherein the at least one releasable binding
is selectively changeable between an engaged condition and a disengaged condition,
wherein in the engaged condition the at least one releasable binding
extends in outwardly overlying relation of the front cushion,
is operative to hold the foot in operatively engaged relation with the foot fixing,
wherein in the disengaged condition the foot is enabled to be disengaged from the foot fixing,
wherein each foot fixing is in operative connection with at least one respective fastener, wherein the at least one fastener is operative to cause a resistance force to be applied by the device that resists vertical movement of the foot fixing,
wherein the resistance force is directed coaxial with a tibia of the user leg the foot of which is being held in operative engagement with the respective foot fixing by the at least one releasable binding in the engaged condition.

2. The apparatus according to claim 1
wherein each foot fixing further includes
a profile spacer, wherein the profile spacer
includes a curved profile spacer surface in facing relation with the front cushion,
wherein in the engaged condition of the at least one releasable binding the profile spacer is positioned intermediate of the front cushion and the at least one binding.

3. The apparatus according to claim 1
wherein each foot fixing further includes
a profile spacer, wherein the profile spacer
is comprised of more rigid material than the front cushion
includes a curved profile spacer surface in facing relation with the front cushion,
wherein in the engaged condition of the at least one releasable binding the profile spacer is positioned intermediate of the front cushion and the at least one binding.

4. The apparatus according to claim 1
wherein each foot fixing further includes
a profile spacer, wherein the profile spacer
includes a curved profile spacer surface in facing relation with the front cushion,
includes and outer spacer surface on an opposed side of the profile spacer from the profile spacer surface,
wherein the outer spacer surface includes at least one guide,
wherein in the engaged condition of the at least one releasable binding
the profile spacer is positioned intermediate of the front cushion and the at least one binding, and
the at least one binding is in engagement with the at least one guide.

5. The apparatus according to claim 1
wherein the at least one releasable binding of each foot fixing includes a pair of adjustable straps, and
wherein each foot fixing further includes
a profile spacer, wherein the profile spacer
includes a curved profile spacer surface in facing relation with the front cushion,
includes an outer spacer surface on an opposed side of the profile spacer from the profile spacer surface,
wherein the outer spacer surface includes a pair of guides,
wherein in the engaged condition of the pair of adjustable straps
the profile spacer is positioned intermediate of the front cushion and each of the straps, and
each strap is in engagement with a respective guide.

6. The apparatus according to claim 1
wherein each foot fixing further includes
a curved rear wall, wherein the curved rear wall is in fixed operative connection with and extends upward from the platform,
wherein the rear cushion is operatively engaged with the rear wall.

7. The apparatus according to claim 1
wherein each foot fixing further includes
a curved rear wall, wherein the curved rear wall
has a U-shape in transverse cross-section, and
is in fixed operative connection with and extends upward from the platform,
wherein the rear cushion has an outer U-shape surface that is operatively engaged with the rear wall.

8. The apparatus according to claim 1
wherein each foot fixing further includes
a curved rear wall, wherein the curved rear wall
is in fixed operative connection with and extends upward from the platform,
includes a back portion and a pair of transversely spaced forward protrusions,
wherein each of the forward protrusions extends on a respective transverse side of the platform and is lower in vertical height than the back portion,
wherein the rear cushion is operatively engaged with the back portion of the rear wall at a vertical height above the forward protrusions, and
wherein at least one of the at least one releasable bindings is in operative engagement with each of the forward protrusions.

9. The apparatus according to claim 1
wherein each foot fixing further includes
a curved rear wall, wherein the curved rear wall
is in fixed operative connection with and extends upward from the platform,
includes a back portion that is U-shape in transverse cross-section and a pair of transversely spaced forward protrusions,
wherein each of the forward protrusions extends on a respective transverse side of the platform and is lower in vertical height than the back portion,
wherein the rear cushion is operatively engaged with and positioned within the U-shape back portion of the rear wall, and
wherein at least one of the at least one releasable bindings is operatively attached to the each of the forward protrusions, and
wherein at least one of the at least one releasable bindings is operatively attached to the U-shaped back portion on each opposed side of the rear cushion.

10. The apparatus according to claim 1
wherein each foot fixing further includes
an anti-slip layer, wherein the anti-slip layer overlies the foot engaging platform.

11. The apparatus according to claim 1
wherein the leg training device includes
a pair of horizontally transversely disposed elongated bars,
wherein each bar includes
a first end that is operatively connected to a respective pivot, and
a second end disposed away from the pivot,
wherein a respective foot fixing is operatively attached to the respective second end of the respective bar by the respective at least one fastener,
wherein vertical movement of a respective foot fixing is operative to cause the respective bar to rotate about the respective pivot.

12. The apparatus according to claim 1
wherein the leg training device includes
a pair of horizontally transversely disposed elongated bars,
wherein each bar includes
a first end that is operatively connected to a respective pivot, and
a second end disposed away from the pivot,
wherein a respective foot fixing is operatively attached to the respective second end of each respective bar by the respective at least one fastener,
at least one weight, wherein the at least one weight is operatively connected to each of the bars,
wherein vertical movement of a respective foot fixing is operative to cause the respective bar to rotate about the respective pivot and raise the at least one weight.

13. The apparatus according to claim 1
wherein the leg training device includes
a pair of horizontally transversely disposed elongated bars,
wherein each bar includes
a first end that is operatively connected to a respective pivot, and
a second end disposed away from the pivot,
wherein a respective foot fixing is operatively attached to the respective second end of each respective bar by the respective at least one fastener,
at least one weight, wherein the at least one weight
is in operative connection with a spindle,
wherein the spindle
is rotatable about a spindle pivot,
wherein the spindle pivot is coaxial with each respective pivot at the respective first ends of the bars,
wherein the spindle is operatively connected to each of the bars,
wherein vertical upward movement of a respective foot fixing is operative to cause the respective bar to rotate about the respective pivot, the spindle to rotate about the spindle pivot and the at least one weight to be raised.

14. The apparatus according to claim 1
wherein the leg training device includes
a pair of horizontally transversely disposed elongated bars,
wherein each bar includes
a first end that is operatively connected to a respective pivot, and
a second end disposed away from the pivot,
wherein a respective foot fixing is operatively attached to the respective second end of each respective bar by the respective at least one fastener,
a rotatable wheel,
a brake, wherein the brake is in operative connection with the wheel and is operative to resist rotation of the wheel,
wherein each elongated bar is in operative connection with the wheel,
wherein vertical movement of each respective foot fixing is operative to cause the respective bar to rotate about the respective pivot and to cause rotation of the wheel.

15. The apparatus according to claim 1
wherein the leg training device includes
a pair of horizontally transversely disposed elongated bars,
wherein each bar includes
a first end that is operatively connected to a respective pivot, and
a second end disposed away from the pivot,
wherein a respective foot fixing is operatively attached to the respective second end of each respective bar by the respective at least one fastener,
a rotatable wheel,
a brake, wherein the brake is in operative connection with the wheel and is operative to apply a brake force to resist rotation of the wheel,
wherein the brake includes at least one magnet, wherein the at least one magnet is movably mounted on the device such that the at least one magnet is selectively positionable at a plurality of distances from the wheel, whereby the brake force is selectively variable,
wherein each elongated bar is in operative connection with the wheel,
wherein vertical movement of each respective foot fixing is operative to cause the respective bar to rotate about the respective pivot and to cause rotation of the wheel.

16. The apparatus according to claim 1
wherein the leg training device includes
a pair of horizontally transversely disposed elongated bars,
wherein each bar includes
a first end that is operatively connected to a respective pivot, and
a second end disposed away from the pivot,
wherein a respective foot fixing is operatively attached to the respective second end of each respective bar by the respective at least one fastener,
a rotatable wheel,
a brake, wherein the brake is in operative connection with the wheel and is operative to apply a brake force to resist rotation of the wheel,
wherein the brake includes at least one magnet, wherein the at least one magnet includes an electromagnet that is operative to provide selectively variable magnetic force that is operative to selectively vary the brake force,
wherein each elongated bar is in operative connection with the wheel,
wherein vertical movement of each respective foot fixing is operative to cause the respective bar to rotate about the respective pivot and to cause rotation of the wheel.

17. The apparatus according to claim 1
wherein the leg training device includes
a pair of transversely disposed elongated bars,
wherein each bar includes
a first end that is operatively connected to a respective pivot, and
a second end disposed away from the pivot,
wherein a respective foot fixing is operatively attached to the respective second end of the respective bar by the respective at least one fastener,
a rotatable wheel,
a brake, wherein the brake is in operative connection with the wheel and is operative to apply a brake force to resist rotation thereof,
wherein each elongated bar is in operative connection with the rotatable wheel through a respective ratchet, wherein the ratchet is operative to apply a movement force from the respective bar to the wheel that is operative to cause the wheel to rotate in a first rotational direction,
wherein vertical movement of a respective foot fixing is operative to cause the respective bar to rotate about the respective pivot and the wheel to rotate in the first rotational direction.

18. The apparatus according to claim 1
wherein the leg training device includes
a pair of transversely disposed elongated bars,
wherein each bar includes
a first end that is operatively connected to a respective pivot, and
a second end disposed away from the pivot,
wherein a respective foot fixing is operatively attached to the respective second end of each respective bar by the respective at least one fastener,
at least one spring, wherein the at least one spring is operative to produce a spring force,
wherein each bar is in operative connection with the at least one spring,
wherein vertical movement of a respective foot fixing
is opposed by the spring force, and
is operative to cause the respective bar to rotate about the respective pivot.

19. The apparatus according to claim 1
wherein the leg training device includes
a pair of transversely disposed elongated bars,
wherein each bar includes
a first end that is operatively connected to a respective pivot, and
a second end disposed away from the pivot,
wherein a respective foot fixing is operatively attached to the respective second end of each respective bar by the respective at least one fastener,
at least one spring, wherein the at least one spring is operative to produce a spring force,
wherein the at least one spring comprises an air spring including at least one piston,
wherein each bar is in operative connection with the at least one spring,
wherein vertical movement of a respective foot fixing
is opposed by the spring force, and
is operative to cause the respective bar to rotate about the respective pivot.

20. The apparatus according to claim 1
wherein the leg training device includes
an elongated flexible tie rod, wherein the tie rod has a first end and a second end,
wherein one foot fixing of the pair of foot fixings is in operative attached connection with the first end of the tie rod through the respective at least one fastener of the foot fixing, and the other foot fixing of the pair is in operative attached connection with the second end of the tie rod through the respective at least one fastener of the foot fixing,
at least one weight, wherein the at least one weight is in operative connection with the tie rod intermediate of the first end and the second end,
wherein vertical movement of a respective foot fixing is operative to move the at least one weight.

21. The apparatus according to claim 1
wherein the leg training device includes
an elongated flexible tie rod, wherein the tie rod has a first end and a second end,
wherein one foot fixing of the pair of foot fixings is in operative attached connection with the first end of the tie rod through the respective at least one fastener of the respective foot fixing, and the other foot fixing of the pair is in operative attached connection with the second end of the tie rod through the respective at least one fastener of the respective foot fixing,
at least one weight, wherein the at least one weight is in operative connection with the tie rod intermediate of the first end and the second end,
wherein vertical movement of one foot fixing upward away from a base is operative to cause the at least one weight to be moved upward while the other foot fixing is biased downward toward the base by the force applied to the tie bar by the at least one weight.

22. The apparatus according to claim 1
wherein the leg training device includes
at least one spring, wherein the at least one spring is operative to apply a selectively variable resistance force,
a pair of respective tie rod portions, wherein each tie rod portion has a first end and the second end,
wherein the first end of each respective tie rod portion is in operatively fixed connection with a respective foot fixing through the respective at least one fastener,
wherein the second end of each respective tie rod portion is in operatively fixed connection with the at least one spring,
wherein vertical movement of each foot fixing is opposed by the selectively variable resistance force.

23. The apparatus according to claim 1
wherein the leg training device includes
at least one spring, wherein the at least one spring is operative to apply a selectively variable resistance force,
a motor, wherein the motor is in operative connection with the at least one spring,
an input device, wherein the input device is in operative connection with the motor, wherein at least one manual input through the input device are operative to cause the motor to change the resistance force,
a pair of respective tie rod portions, wherein each tie rod portion has a first end and the second end,
wherein the first end of each respective tie rod portion is in operatively fixed connection with a respective foot fixing through the respective fastener,
wherein the second end of each respective tie rod portion is in operatively fixed connection with the at least one spring,
wherein vertical movement of each foot fixing is opposed by the selectively variable resistance force.

24. Apparatus comprising:
a leg training device configured to provide resistance to vertical movement of each foot of the user of the device,
wherein the device includes a pair of foot fixings that are each in permanent operative engagement with the device,
wherein each foot fixing is configured to hold a respective user foot in operative engagement with the respective foot fixing as a user's leg is moved vertically upward and downward during device operation,
wherein each foot fixing includes
a supporting platform, wherein the platform is configured to operatively engage a bottom of one respective user foot, wherein the platform is configured to underlie at least the toes and heel of the respective foot,
a resilient rear cushion, wherein the rear cushion
extends above and in operatively fixed connection with the platform,
includes a curved leg engagement surface,
wherein the curved leg engagement surface is configured to engage a back side of the user leg above the foot when the foot is in operative engagement with the foot fixing,
a resilient front cushion, wherein the front cushion
includes an engagement surface configured to engage an instep of the user foot in operative connection with the foot fixing,
at least one releasable binding, wherein each at least one releasable binding
is selectively changeable between an engaged condition and to disengaged condition,
wherein in the engaged condition the at least one releasable binding
extends in outwardly overlying relation of the front cushion, and
is operative to hold the user foot in operatively engaged relation with the foot fixing,
wherein in the disengaged condition the user foot is enabled to be disengaged from the foot fixing,
wherein each foot fixing is in operative connection with at least one respective fastener, wherein the at least one fastener is operative to cause a resistance force to be applied to the device that resists vertically upward movement of the foot fixing,
wherein the resistance force is directed coaxial with a tibia of the user leg the foot or which is held in operative engagement with the respective foot fixing by the at least one releasable binding in the engaged condition.
